(19) United States
(12) Patent Application Publication
(10) Pub. No.: US 2006/0060050 A1
(43) Pub. Date: Mar. 23, 2006

(54) Shearing machine for transversally dividing a heavy plate by means of an eccentric drive

(76) Inventors: Gerhard Heitze, Netphen (DE); Thomas Baur, Hilchenbach (DE)

Correspondence Address: FRIEDRICH KUEFFNER, 317 MADISON AVENUE, SUITE 910, NEW YORK, NY, 10017, US

(21) Appl. No.: 10/539,529

(22) PCT Filed: Dec. 15, 2003
(86) PCT No.: PCT/EP03/14233

§ 371 Date: Jun. 17, 2005

(30) Foreign Application Priority Data
Dec. 20, 2002 (DE) 102 59 903.3

(51) Int. Cl. B23D 19/00; B23D 19/04

(52) U.S. Cl. 83/515; 83/517; 83/498; 83/477

(57) ABSTRACT

The invention relates to a shearing machine for transversally dividing especially a heavy steel plate, said shearing machine comprising an upper blade (3) which carries out a rolling cutting movement by means of an eccentric drive (8) and is held in a blade carrier (1), and a lower blade (4) which is arranged in the frame of the shearing machine (2) in a fixed manner, the upper blade carrier (1) being displaceably connected to a stand (6) of the shearing machine frame (2) by means of an articulated guiding element (5). A device for the clocked advance of a pre-determinable length of the steel plate is associated with the shearing machine, especially in the form of at least one driving element. The aim of the invention is to improve the stability of the shearing machine and thus the quality of the cut. To this end, the shearing machine is arranged between lateral stands (6, 6′) of the shearing machine frame (2) which is closed by an upper traverse (7) and a lower traverse (7′). The eccentric drive (8, 8′) of the upper blade (3) is arranged in the upper region of said frame, and bearings (10, 10′) and driving bodies (11) of lower driving rolls (12, 12′) are arranged in the lower region of said frame, in addition to a lower blade table (9) which is anchored between the stands (6, 6′).

The invention concerns a shear for cutting especially heavy steel plate to length with an upper blade, which carries out a rolling cutting movement by means of an eccentric drive and is held in a blade holder, and with a lower blade, which is mounted in a stationary way in the shear frame, wherein the upper blade holder is movably connected by an articulated guide element with a shear frame column present on the shear, and a device for the timed advance of predeterminable lengths of the steel plate, especially in the form of at least one driver, is assigned to the shear.

Curved-blade cut-to-length shears of the aforementioned design and their operating sequences are well known. Their function can be described as follows:

The plate to be cut is conveyed by a roller table to a point before the shear. Drivers push it against an aligning strip before the first cut. The plate then moves into the first cutting position, and the drivers close before the shear. The first cut is then carried out. Scrap pieces and test strips are removed and, as circumstances require, pulverized.

For further cuts, length-measuring rollers control the driver according to the programmed plate length. After the cutting has been carried out, the plates are conveyed to a connecting roller table by a depressing table.

The cut-to-length shear is equipped with a curved upper blade and a straight lower blade. It works by the rolling cutting principle: The upper blade carries out a rolling movement. Due to this rolling movement of the curved blade, only a slight overcut relative to the straight lower blade is formed; as a result, the plates remain practically free of transverse bends and are quickly released by the blades for further conveyance. In addition, only a short lift of the depressing table is necessary. The cut plates fall from a low height, so that the noise can be significantly reduced.

The upper blade is driven by direct-current motors via gears, crankshafts, and pitmen. The gearbox is horizontally divisible and thus allows easy access for maintenance purposes.

To obtain clean cuts of the plate, the gap between the upper blade and the lower blade can be infinitely adjusted according to the thickness and grade of the material. A plate-holding device working together with hold-downs of the shear guarantees rectangular plate formats.

Driving rolls that can be adjusted to the plate width are arranged at least on the inlet side of the shear. In conjunction with the length-measuring systems, they produce exact conveyance of the plates consistent with the preselected cut length value of a cutting program.

The arrangement of the driving rolls on adjustable swivel bearings guarantees directionally stable conveyance and thus parallel cut edges of the cut-to-length plate. If the driving rolls are opened at the tail end of the plate, pressure rollers assist the plate conveyance.

Length-measuring rollers are preferably used for automatically running cutting programs with frequently changing finished lengths—even within a single rolled plate. They control the driving rolls during the conveyance of the plate.

German Patent 23 29 095 describes a slitting shear for rolled plates, especially for thick plates, with a curved upper blade that carries out a rolling cutting movement and with a stationary, straight lower blade, wherein the upper blade can be preset relative to the lower blade to different depths of penetration according to the different plate thicknesses. A roll body, which extends slightly beyond the cutting edge of the upper blade, is supported before the insertion end of the upper blade in the upper blade holder. The roll body is preferably a roll that is supported in such a way that it can rotate freely about an axis arranged transversely to the cutting edge of the upper blade. At the front end of the lower blade, approximately below the rollers, a support roll is supported, which extends slightly beyond the cutting edge of the lower blade. This prevents the moving plate and the upper blade from sliding into each other during the operation.

The document DE-AS 17 77 014 describes a shear for trimming or cutting plates. It has a stationary lower blade and an upper blade that is mounted on a blade holder and has a curved cutting edge. The upper blade can be driven to carry out a rolling cutting movement, during which it is secured against displacement in the longitudinal direction of the blade by a guide that is rigidly mounted on a column. The guide is formed by vertical guide surfaces that extend transversely to the cutting plane. The guide surfaces hold a sliding block between them, which is rotatably supported on the upper blade holder in the middle of the blade. The extended axis of rotation of the sliding block runs through the cutting edge of the upper blade.

The document DE 24 57 222 A1 discloses a shearing device with a stationary blade and a cooperating moving blade, which is made to carry out a swinging or rolling cutting movement relative to the stationary blade by an eccentric mechanism. A fluid-operated drive device is operatively coupled in such a way that the moving blade is driven and moved back and forth in its cutting movement.

The document DE-AS 26 58 137 describes a rolling shear with an opposing blade rigidly mounted on an opposing frame and a downwardly bent blade mounted on an upper blade holder. The downwardly bent blade is connected with an eccentric mechanism that imparts a swinging motion to the blade. The upper blade holder is connected with a shear frame assigned to the starting side of the cut by a guide rod that is articulated at each end. The essential characteristic of this rolling shear is that the point on the upper blade holder that corresponds essentially to the longitudinal center point of the upper blade is connected with the shear frame by the guide rod in such a way that it can move only along a circular arc of constant radius, and that the guide rod extends essentially parallel to the lower blade. The guide rod is preferably connected with the blade holder by means of a spherical bearing.

U.S. Pat. No. 1,986,685 discloses a circular shear for metal plates, which has upper blades that can be moved eccentrically about a center of rotation by an eccentric drive, a straight lower blade, and hold-downs.

The document DE 34 02 567 A1 describes a device for the cutting of concrete-reinforcing bar with feed conveyors, delivery conveyors, and a separating shear in a common machine frame. The separating shear has an upper blade and a stationary opposing blade located below the feed plane. Drivers are present for the timed advance of the concrete-reinforcing bar to be cut. It is not intended that wide heavy plates should be cut with this separating shear.

Proceeding from the aforementioned prior art, the invention is based on the specific objective of systematically further improving a shear of the design specified in the introductory clause of Claim 1 in order to adapt it to the increased output of rolling mills and to design it in such a way that it meets the growing demands on accuracy to gage, flatness, and surface condition of the plates, as well as ease of maintenance and availability of the installations.

The invention achieves this objective by arranging the shear between lateral columns of a shear frame with a closed construction with one upper and one lower cross-frame, such that the eccentric drives of the upper blade are installed in the upper region of the shear frame, and in the lower region of the shear frame, bearings and drive mechanisms of the lower driving rolls are installed, and a lower blade table is rigidly mounted between the columns, and by assigning a lower gearbox, which has a central bearing in addition to the bearings of the lower driving rolls, to the lower blade table.

The advantageous design feature is the special rigidity of the cut-to-length shear due to the closed column and the mounting of the lower blade table between the shear columns. At the same time, the lower gearbox and the faceplate are mounted between the shear columns. The cutting forces are thus introduced directly into the shear columns, so that there is a direct flow of force.

In one embodiment of the shear design, the shear has an arrangement of drivers in which there is one driver with an upper driver contact roll before the upper blade and one driver with an upper driver contact roll after the upper blade.

In another embodiment of the design of the shear, the driver contact roll is assigned a guide rail with an adjustment drive, which allows adjustment of the roll bearing for the purpose of adaptation to the width of a partial plate.

Furthermore, in an improved embodiment of the design of the shear, the run-in driver located before the shear blades is arranged at the shortest distance from them in such a way that the longest possible conveyance with the run-in driver is obtained. The run-in driver is moved up closer to the shear blades, for example, with shortening of the previously customary distances from 1,650 mm to 800 mm.

The invention further proposes that the rear driver is designed and arranged in such a way that it holds the partial plates during the cutting apart in addition to the hold-downs to avoid an angular displacement.

It is further proposed that the contact roll of the run-in driver is arranged on a lever system, which transmits a conveyance contact force to the lower driving roll by means of a hydraulic cylinder.

It is advantageous for the rear driver to have a driven lower driving roll, which is supported on a bracket and at the same time acts as a roller table roller.

Especially reliable guidance of the shear blades is achieved by mounting the lower blade table and the bottom faceplate between the shear columns in such a way that the cutting forces are introduced directly into the shear columns, so that there is a direct flow of force.

The rear contact roll is guided on a slide with rollers and is adjusted to the specific partial plate width by an electric geared motor with rack and pinion. The rear contact roll, like the front contact roll, is set down on the partial plate by means of a hydraulic cylinder. During the conveyance of the plate, the slide is hydraulically clamped with the contact roll. The new design features significantly reduce the costs, especially of the drivers, and improve the quality of the product.

The cut-to-length shear of the invention is explained in greater detail below with reference to the drawings.

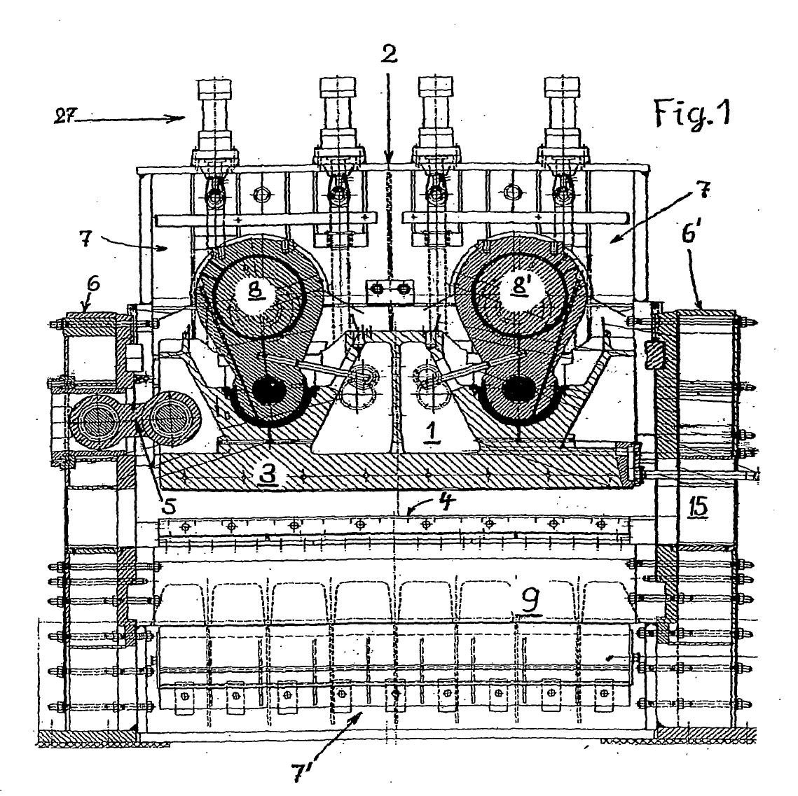

FIG. 1 shows a front elevation of the cut-to-length shear with the faceplate removed and with a view towards the upper blade drive mechanisms.

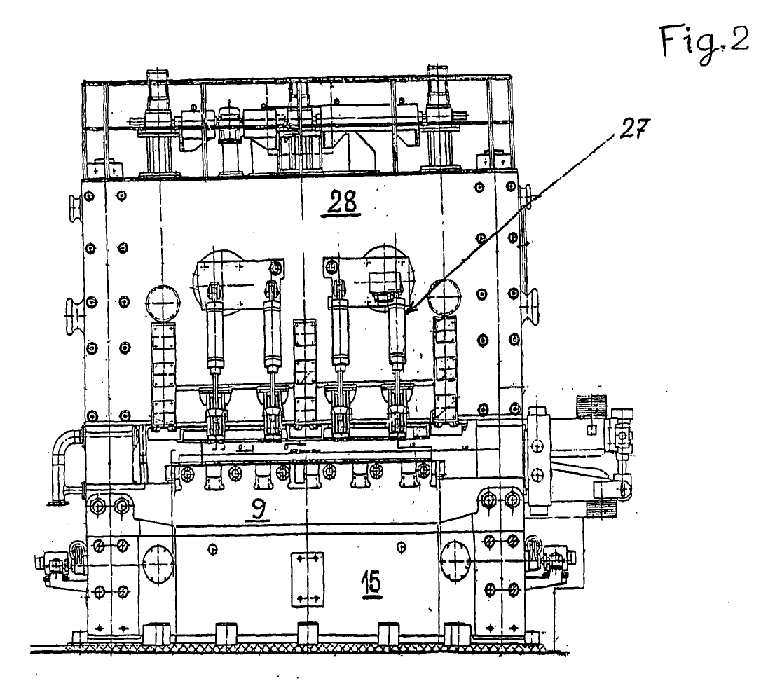

FIG. 2 shows a front elevation of the cut-to-length shear.

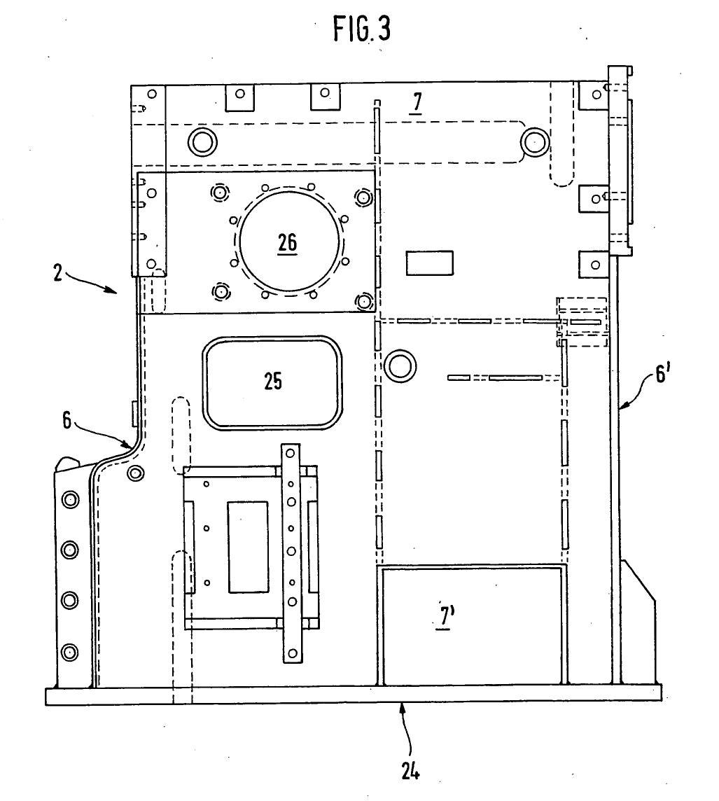

FIG. 3 shows a side view of the shear column.

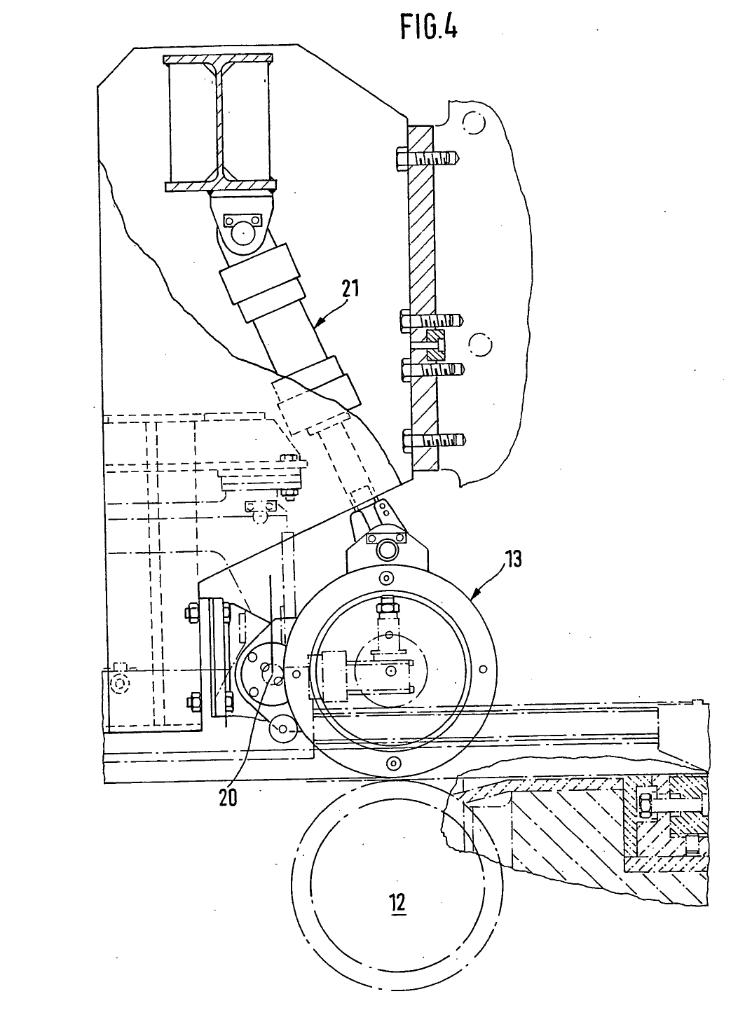

FIG. 4 shows a disposition of driver rolls before the cut-to-length shear in a side view.

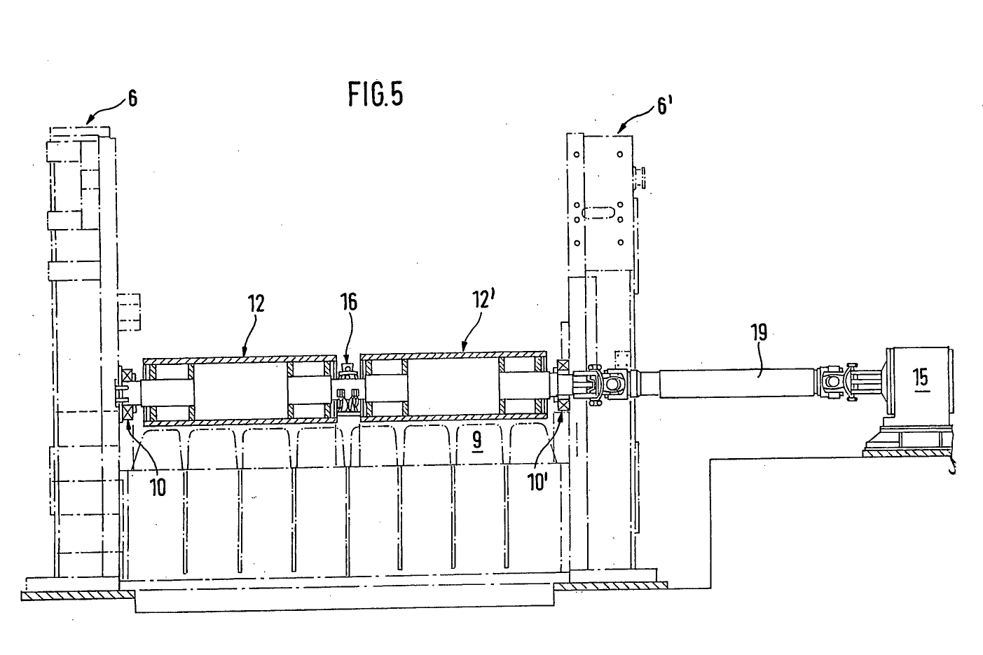

FIG. 5 shows a partially cutaway front elevation of a pair of driver rolls before the shear.

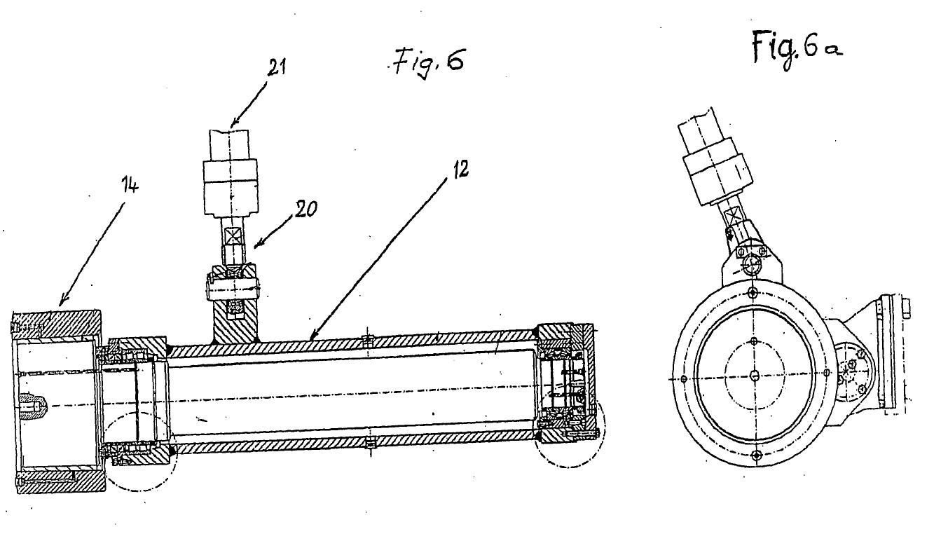

FIG. 6 shows a sectional view of a driver roll, including its bearing.

FIG. 6a shows pressure application by a hydraulic cylinder viewed in the direction of its axis.

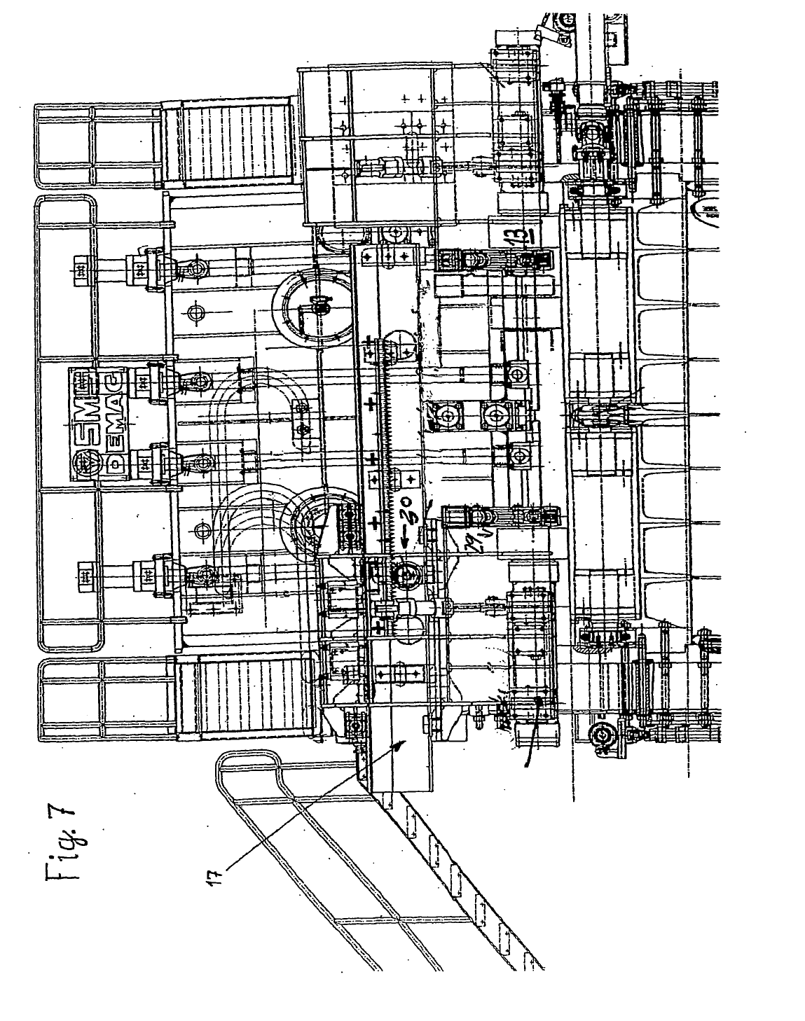

FIG. 7 shows the adjustment drive and adjustable driver roll for the adaptation to plate widths.

FIG. 1 shows a front elevation of the cut-to-length shear with the faceplate removed. The exposed inside of the shear reveals the blade holder 1 with the upper blade 3. The drive mechanisms are the eccentric drives 8, whose swinging motion, which is produced by rotation, is transmitted to the blade holder 1 by downwardly directed push rods and causes it to make a rolling cutting movement.

The blade holder 1 is movably connected with the stationary column 6 of the shear frame 2 by means of the guide element 5. This prevents deflection of the blade holder 1 in the lateral direction.

In addition, the drawing shows that the lower blade 4 is rigidly mounted between the columns 6, 6′. This provides the entire structure of the shear frame 2 with secure stability in every direction.

The stability of the shear frame 2 is further increased by bolting the lower blade table 9 to the columns 6, 6′, likewise on both sides, in the lower region of the frame.

FIG. 2 shows a front view of the cut-to-length shear with the faceplate 28 mounted on the frame 2. The drawing shows a series of hold-downs 27 with hydraulic cylinders for introducing force. As shown, the front faceplate 28 is mounted on the columns 6 by bolted connections, so that the faceplate can be quickly removed in an uncomplicated way for purposes of maintenance of the driving gear on the inside.

FIG. 3 shows a side view of the frame 2 of the shear with a window 25, through which the shear blades can be replaced from the side without any difficulty. An opening 26 is provided for the eccentric bearing of the upper blade gear, which is equipped with the eccentric drives 8. A bottom faceplate 24 is provided as a stationary foundation for the housing of the shear.

FIG. 4 shows an arrangement of the drivers, in which a driver with an upper driver contact roll 13, preferably before the upper blade 3, and a driven driver 12 are arranged to act together.

FIG. 5 shows an arrangement of driven lower driving rolls 12, 12′ with a central bearing above the lower blade table 9 with a lower gearbox for driving the two driving rolls 12, 12′.

FIG. 6 shows a rear contact roll 14 on a lever system 20, which transmits a conveyance contact force to the lower driving roll by means of a hydraulic cylinder 21.

Finally, FIG. 7 shows that the adjustable driver contact roll 29 is assigned a guide rail 17 with an adjustment drive 30, which allows adjustment of the roll bearing in its distance from the stationary driver contact roll 13 for the purpose of adaptation to the width of a partial plate.

As mentioned earlier, the lower blade table 9 and the bottom faceplate 24 are mounted between the shear columns 6, 6′ in such a way that the cutting forces are introduced directly into the shear columns 6, 6′, so that there is a direct flow of force.

### LIST OF REFERENCE NUMBERS

1. blade holder
2. shear frame
3. upper blade
4. lower blade
5. guide element
6. column
7. upper cross-frame/lower cross-frame
8. eccentric drives
9. lower blade table
10. bearing
10′. bearing
11. drive mechanisms
12. lower driving rolls
13. front driver contact roll
14. rear driver contact roll
15. lower gearboxes
16. central bearing
17. guide rail
19. drive shaft
20. lever system
21. hydraulic cylinder
22. bracket
24. bottom faceplate
25. window
26. opening for eccentric bearing.
27. hold-down
28. front faceplate
29. adjustable driver contact roll
30. adjustment drive

1. Shear for cutting especially heavy steel plate to length with an upper blade (3), which carries out a rolling cutting movement by means of an eccentric drive (8) and is held in a blade holder (1), and with a lower blade (4), which is mounted in a stationary way in the shear frame (2), wherein the upper blade holder (1) is movably connected by an articulated guide element (5) with a shear frame column (6) present on the shear, and a device for the timed advance of predeterminable lengths of the steel plate, especially in the form of at least one driver, is assigned to the shear, wherein the shear is arranged between lateral columns (6, 6′) of a shear frame (2) with a closed construction with one upper cross-frame (7) and one lower cross-frame (7′), such that the eccentric drives (8, 8′) of the upper blade (3) are installed in the upper region of the shear frame (2), and in the lower region of the shear frame (2), bearings (10, 10′) and drive mechanisms (11) of the lower driver rolls (12, 12′) are installed, and a lower blade table (9) is rigidly mounted between the columns (6, 6′), and that the lower blade table (9) is assigned a lower gearbox (15), which has a central bearing (16) in addition to the bearings (10, 10′) of the lower driver rolls (12, 12′).

2. Shear in accordance with claim 1, wherein one driver with an upper driver contact roll (13) is present before the upper blade (3) and one driver with an upper driver contact roll (14) is present after the upper blade (3) (FIG. 4, FIG. 6).

3. Shear in accordance with claim 1, wherein the driver contact roll (29) is assigned a guide rail (17) with an adjustment drive (30), which allows adjustment of the roll bearing for the purpose of adaptation to the width of a partial plate.

4. Shear in accordance with claim 1, wherein the run-in driver (13), which is located before the blades (3, 4), is arranged at the shortest distance from them in such a way that the longest possible conveyance with the run-in driver (13) is obtained.

5. Shear in accordance with claim 1, wherein the rear driver is designed and arranged in such a way that it holds the partial plates during the cutting apart in addition to the hold-downs to avoid an angular displacement.

6. Shear in accordance with claim 1, wherein the contact roll (13) of the run-in driver is arranged on a lever system (20), which transmits a conveyance contact force to the lower driving roll by means of a hydraulic cylinder (21).

7. Shear in accordance with that claim 1, wherein the rear driver has a driven lower driving roll (14), which is supported on a bracket (22) and at the same time acts as a roller table roller.

8. Shear in accordance with claim 1, wherein the lower blade table (9) and the bottom faceplate (24) are mounted between the shear columns (6, 6′) in such a way that the cutting forces are introduced directly into the shear columns (6, 6′), so that there is a direct flow of force.

9. Shear in accordance with claim 1, wherein an adjustable contact roll (29) is connected with an adjustment drive (30), is preferably guided on a slide with rollers, and can be adjusted to the specific partial plate width by an electric geared motor with rack and pinion, and that the contact roll (29) can be set down on the partial plate by means of a hydraulic cylinder, and during the conveyance of the plate, the slide is hydraulically clamped with the contact roll.
